(19) United States
(12) Patent Application Publication
(10) Pub. No.: US 2026/0323467 A1
(43) Pub. Date: Oct. 15, 2026

(54) METHOD AND DEVICE FOR CHANGING DATA TRANSMISSION PATH IN NEXT-GENERATION WIRELESS COMMUNICATION SYSTEM

(71) Applicant: Samsung Electronics Co., Ltd., Suwon-si, Gyeonggi-do (KR)

(72) Inventors: Sangho LEE, Suwon-si (KR); Sunhyun KIM, Suwon-si (KR); Jiyoung CHA, Suwon-si (KR)

(21) Appl. No.: 19/129,248

(22) PCT Filed: Nov. 22, 2023
(86) PCT No.: PCT/KR2023/018870

§ 371 Date: May 12, 2025

(30) Foreign Application Priority Data
Dec. 6, 2022 (KR) 10-2022-0168734

(51) Int. Cl. H04W 36/36; H04W 36/00; H04W 36/30; H04W 72/21

(52) U.S. Cl. CPC H04W 36/362; H04W 36/0069; H04W 36/302; H04W 72/21

(57) ABSTRACT

The present disclosure relates to a 5G or 6G communication system for supporting higher data transmission rates than 4G communication systems such as LTE. Disclosed are a method and device for changing a data transmission path for improving the coverage in a next-generation wireless communication system.

### TECHNICAL FIELD

The disclosure relates to a method and a device for changing a data transmission path in order to improve the coverage in a next-generation mobile communication system.

### BACKGROUND ART

A review of the development of wireless communication from generation to generation shows that the development has mostly been directed to technologies for services targeting humans, such as voice-based services, multimedia services, and data services. It is expected that connected devices which are exponentially increasing after commercialization of 5th generation (5G) communication systems will be connected to communication networks. Examples of things connected to networks may include vehicles, robots, drones, home appliances, displays, smart sensors installed in various infrastructures, construction machines, factory equipment, and the like. Mobile devices are expected to evolve in various formfactors, such as augmented reality glasses, virtual reality headsets, and hologram devices. In order to provide various services by connecting hundreds of billions of devices and things in the 6th-generation (6G) era, there have been ongoing efforts to develop improved 6G communication systems. For these reasons, 6G communication systems are referred to as “beyond-5G” systems.

6G communication systems, which are expected to be implemented approximately by 2030, will have a maximum transmission rate of tera (1,000 giga)-level bps and a radio latency of 100 μsec. That is, 6G communication systems will be 50 times as fast as 5G communication systems and have the 1/10 radio latency thereof.

In order to accomplish such a high data transmission rate and an ultra-low latency, it has been considered to implement 6G communication systems in a terahertz band (for example, 95 GHz to 3 THz bands). It is expected that, due to severer path loss and atmospheric absorption in the terahertz bands than those in mmWave bands introduced in 5G, a technology capable of securing the signal transmission distance (that is, coverage) will become more crucial. It is necessary to develop, as major technologies for securing the coverage, multiantenna transmission technologies including radio frequency (RF) elements, antennas, novel waveforms having a better coverage than OFDM, beamforming and massive MIMO, full dimensional MIMO (FD-MIMO), array antennas, and large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the frequency efficiencies and system networks, the following technologies have been developed for 6G communication systems: a full-duplex technology for enabling an uplink (UE transmission) and a downlink (node B transmission) to simultaneously use the same frequency resource at the same time; a network technology for utilizing satellites, high-altitude platform stations (HAPS), and the like in an integrated manner; a network structure innovation technology for supporting mobile nodes B and the like and enabling network operation optimization and automation and the like; a dynamic spectrum sharing technology though collision avoidance based on spectrum use prediction, an artificial intelligence (AI)-based communication technology for implementing system optimization by using AI from the technology design step and internalizing end-to-end AI support functions; and a next-generation distributed computing technology for implementing a service having a complexity that exceeds the limit of UE computing ability by using super-high-performance communication and computing resources (mobile edge computing (MEC), clouds, and the like). In addition, attempts have been continuously made to further enhance connectivity between devices, further optimize networks, promote software implementation of network entities, and increase the openness of wireless communication through design of new protocols to be used in 6G communication systems, development of mechanisms for implementation of hardware-based security environments and secure use of data, and development of technologies for privacy maintenance methods.

It is expected that such research and development of 6G communication systems will enable the next hyper-connected experience in new dimensions through the hyper-connectivity of 6G communication systems that covers both connections between things and connections between humans and things. Specifically, it is expected that services such as truly immersive XR, high-fidelity mobile holograms, and digital replicas could be provided through 6G communication systems. In addition, with enhanced security and reliability, services such as remote surgery, industrial automation, and emergency response will be provided through 6G communication systems, and thus these services will be applied to various fields including industrial, medical, automobile, and home appliance fields.

The THz frequency bands used in 6G systems to secure wide bandwidths cause problems in that signals are attenuated in the receiver, and the cell coverage is decreased. A larger number of antennas may be used to solve the problem of propagation distance and coverage, but the small beam widths at high frequencies require the use of an improved beamforming technology such that an optimal pair of transmission/reception beams is found by adjusting the transmission beam and reception beam, for the sake of efficient communication.

Meanwhile, high frequencies have weak diffraction and have difficulty in penetrating obstacles. Such characteristics result in the effect of blocking by various obstacles, or the effect of hand grip regarding the UE. This heavily affects the UE-side reception performance. Therefore, it is necessary to consider a communication method capable of further improving the performance while using the beamforming technology.

### DISCLOSURE OF INVENTION

### Technical Problem

Therefore, an aspect of the disclosure is to propose a communication method capable of improving the UE-side reception performance.

More specifically, an aspect of the disclosure is to propose a method capable of improving the reception performance by changing the data path in a temporary signal disconnection situation.

### Solution to Problem

A method performed by a terminal in a wireless communication system according to an example of the disclosure may include: identifying whether a condition to change a transmission path of data for a second base station of a second radio access technology (RAT) to a transmission path for a first base station of a first RAT is satisfied, a dual connectivity (DC) being configured for the second base station with the first base station; in case that the condition is satisfied, generating information for requesting to change a data transmission path; and transmitting, to the first base station, the generated information.

A method performed by a first base station in a wireless communication system according to an example of the disclosure may include: receiving, from a terminal, information for requesting to change a transmission path of data for a second base station of second radio access technology (RAT) to a transmission path for a first base station of a first RAT, a dual connectivity (DC) being configured for the second base station with the first base station; receiving, from the terminal, uplink data associated with the second base station, based on the information; and transmitting, to the terminal, downlink data associated with the second base station.

A terminal in a wireless communication system according to an example of the disclosure may include: a transceiver; and
a controller configured to identify whether a condition to change a transmission path of data for a second base station of a second radio access technology (RAT) to a transmission path for a first base station of a first RAT is satisfied, a dual connectivity (DC) being configured for the second base station with the first base station, in case that the condition is satisfied, generate information for requesting to change a data transmission path, and control the transceiver to transmit, to the first base station, the generated information.

A first base station in a wireless communication system according to an example of the disclosure may include: a transceiver; and a controller configured to control the transceiver so as to receive, from a terminal, information for requesting to change a transmission path of data for a second base station of second radio access technology (RAT) to a transmission path for a first base station of a first RAT, a dual connectivity (DC) being configured for the second base station with the first base station, control the transceiver to receive, from the terminal, uplink data associated with the second base station, based on the information, and control the transceiver to transmit, to the terminal, downlink data associated with the second base station.

### Advantageous Effects of Invention

The disclosure is advantageous in that, in case that a beamforming system is operated in a non-standalone (NSA) situation, a radio connection to a UE may be supported in consideration of different frequency characteristics of respective base station signals, thereby overcoming the UE's temporary signal disconnection, and improving the user's experiences and the system performance.

### BRIEF DESCRIPTION OF DRAWINGS

FIG. 1 illustrates an LTE system to which the disclosure is applicable.

FIG. 2 illustrates a radio protocol structure of an LTE system to which the disclosure is applicable.

FIG. 3 illustrates a next-generation mobile communication system to which the disclosure is applicable.

FIG. 4 illustrates a radio protocol structure of a next-generation mobile communication system to which the disclosure is applicable.

FIG. 5A illustrates signal patterns in respective wireless communication networks.

FIG. 5B illustrates communication situations in high-frequency areas.

FIG. 6A illustrates an exemplary situation that may occur in a high-frequency area.

FIG. 6B illustrates a change in signal performance between a UE and a base station according to the exemplary situation in FIG. 6A.

FIG. 7A illustrates a cell coverage according to an exemplary situation of the disclosure.

FIG. 7B illustrates a base station's connection support procedure based on the cell coverage in FIG. 7A.

FIG. 8A illustrates a cell coverage according to an embodiment of the disclosure.

FIG. 8B illustrates a base station's connection support procedure, based on the cell coverage in FIG. 8A.

FIG. 9 is a flowchart illustrating operations of a UE for determining conditions to change a data path according to an embodiment of the disclosure.

FIG. 10 illustrates determination conditions according to an embodiment of the disclosure.

FIG. 11 illustrates a comparison between a data path change procedure proposed in the disclosure and a legacy procedure.

FIG. 12 is a flowchart illustrating operations of a UE for a data path change according to an embodiment of the disclosure.

FIG. 13 is a flowchart illustrating operations of a base station for a data path change according to an embodiment of the disclosure.

FIG. 14 illustrates a data transmission path in connection with a bearer structure according to an embodiment of the disclosure.

FIG. 15A illustrates the structure of a PDCP data PDU for requesting a data transmission path change according to an example of the disclosure.

FIG. 15B illustrates the structure of a PDCP control PDU for requesting a data transmission path change according to an example of the disclosure.

FIG. 15C illustrates the structure of a new PDCP control PDU for requesting a data transmission path change according to an example of the disclosure.

FIG. 16 illustrates the structure of a MAC CE for requesting a data transmission path change according to an example of the disclosure.

FIG. 17 illustrates the entire operations according to an example of the disclosure.

FIG. 18 is a block diagram illustrating a structure of a UE to which the disclosure is applicable.

FIG. 19 is a block diagram illustrating a structure of a base station in a wireless communication system to which the disclosure is applicable.

### MODE FOR THE INVENTION

Hereinafter, the operation principle of the disclosure will be described in detail in conjunction with the accompanying drawings. In describing the disclosure below, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In describing the disclosure below, a detailed description of known functions or configurations incorporated herein will be omitted when it is determined that the description may make the subject matter of the disclosure unnecessarily unclear. Hereinafter, embodiments of the disclosure will be described with reference to the accompanying drawings.

In the following description, terms for identifying access nodes, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

In the following description, terms and names defined in the 3rd generation partnership project long term evolution (3GPP LTE) standards may be used for the sake of descriptive convenience. However, the disclosure is not limited by these terms and names, and may be applied in the same way to systems that conform other standards. In the disclosure, the term “eNB” may be interchangeably used with the term “gNB” for the sake of descriptive convenience. That is, a base station described as “eNB” may refer to “gNB”.

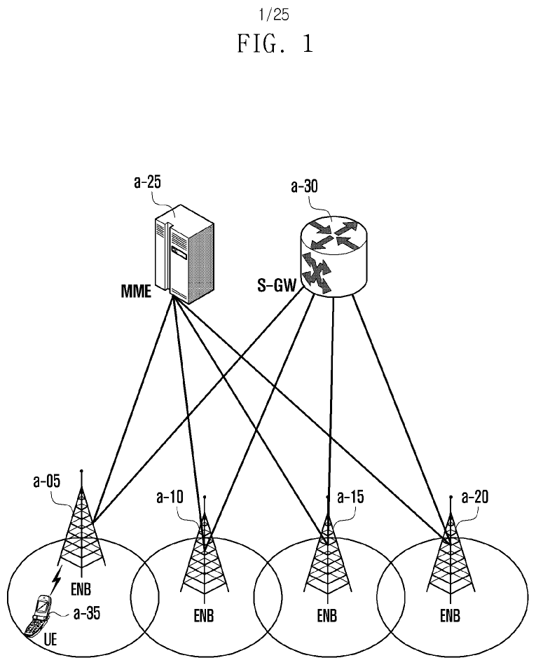

FIG. 1 illustrates a structure of an LTE system to which the disclosure is applicable.

Referring to FIG. 1, as illustrated therein, a radio access network of an LTE system includes next-generation base stations (evolved node Bs, hereinafter ENBs, node Bs, or base stations) a-05, a-10, a-15, and a-20, a mobility management entity (MME) a-25, and a serving gateway (S-GW) a-30. A user equipment (hereinafter UE or terminal) a-35 accesses an external network through the ENBs a-05, a-10, a-15, and a-20 and the S-GW a-30.

In FIG. 1, the ENBs a-05 to a-20 each correspond to a conventional node B in a UMTS system. The ENBs are connected to the UE a-35 through a radio channel, and perform more complicated roles than the conventional node Bs. In the LTE system, since all user traffic including real-time services, such as voice over IP (VOIP) via the Internet protocol, is serviced through a shared channel, a device that collects state information, such as buffer states, available transmit power states, and channel states of UEs, and performs scheduling accordingly is required, and the ENBs 1-05 to 1-20 serve as the device. In general, one ENB controls multiple cells. For example, in order to implement a transfer rate of 100 Mbps, the LTE system uses orthogonal frequency division multiplexing (hereinafter referred to as OFDM) as a radio access technology in a bandwidth of, for example, 20 MHz. Furthermore, the next-generation mobile communication system employs an adaptive modulation & coding (hereinafter referred to as AMC) scheme for determining a modulation scheme and a channel coding rate according to a channel state of a UE. The S-GW a-30 is a device that provides a data bearer, and generates or remove a data bearer under the control of the MME a-25. The MME is a device responsible for various control functions as well as a mobility management function for a UE, and is connected to multiple base stations.

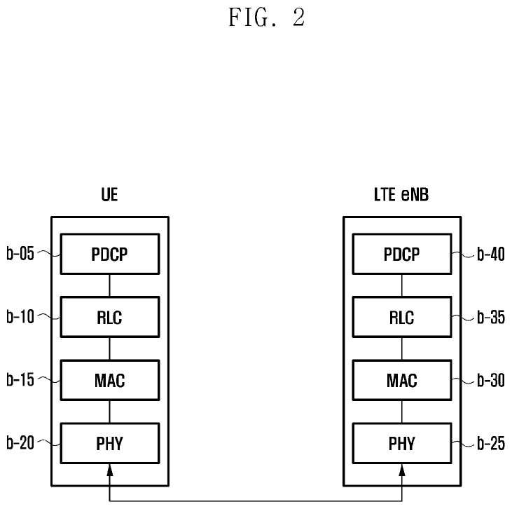

FIG. 2 illustrates a radio protocol structure of an LTE system to which the disclosure is applicable.

Referring to FIG. 2, a radio protocol of an LTE system includes a packet data convergence protocol (PDCP) b-05 or b-40, a radio link control (RLC) b-10 or b-35, and a medium access control (MAC) b-15 or b-30 on each of UE and ENB sides. The packet data convergence protocol (PDCP) b-05 or b-40 is responsible for operations such as IP header compression/reconstruction. The main functions of the PDCP are summarized as follows.
Header compression and decompression: ROHC only
Transfer of user data
In-sequence delivery of upper layer PDUs at PDCP re-establishment procedure for RLC AM
For split bearers in DC (only support for RLC AM): PDCP PDU routing for transmission and PDCP PDU reordering for reception
Duplicate detection of lower layer SDUs at PDCP re-establishment procedure for RLC AM
Retransmission of PDCP SDUs at handover and, for split bearers in DC, of PDCP PDUs at PDCP data-recovery procedure, for RLC AM
Ciphering and deciphering
Timer-based SDU discard in uplink

The radio link control (hereinafter referred to as RLC) b-10 or b-35 reconfigures a PDCP protocol data unit (PDU) into an appropriate size to perform an ARQ operation. The main functions of the RLC are summarized as follows.
Transfer of upper layer PDUs
Error Correction through ARQ (only for AM data transfer)
Concatenation, segmentation and reassembly of RLC SDUs (only for UM and AM data transfer)
Re-segmentation of RLC data PDUs (only for AM data transfer)
Reordering of RLC data PDUs (only for UM and AM data transfer)
Duplicate detection (only for UM and AM data transfer)
Protocol error detection (only for AM data transfer)
RLC SDU discard (only for UM and AM data transfer)
RLC re-establishment

The MAC b-15 or b-30 is connected to several RLC layer devices configured in a single terminal, and multiplexes RLC PDUs into a MAC PDU and demultiplexes a MAC PDU into RLC PDUs. The main functions of the MAC are summarized as follows.
Mapping between logical channels and transport channels
Multiplexing/demultiplexing of MAC SDUs belonging to one or different logical channels into/from transport blocks (TB) delivered to/from the physical layer on transport channels
Scheduling information reporting
Error correction through HARQ
Priority handling between logical channels of one UE
Priority handling between UEs by means of dynamic scheduling
MBMS service identification
Transport format selection
Padding

A physical layer b-20 or b-25 performs operations of channel-coding and modulating upper layer data, thereby obtaining OFDM symbols, and delivering the same through a radio channel, or demodulating OFDM symbols received through the radio channel, channel-decoding the same, and delivering the same to the upper layer.

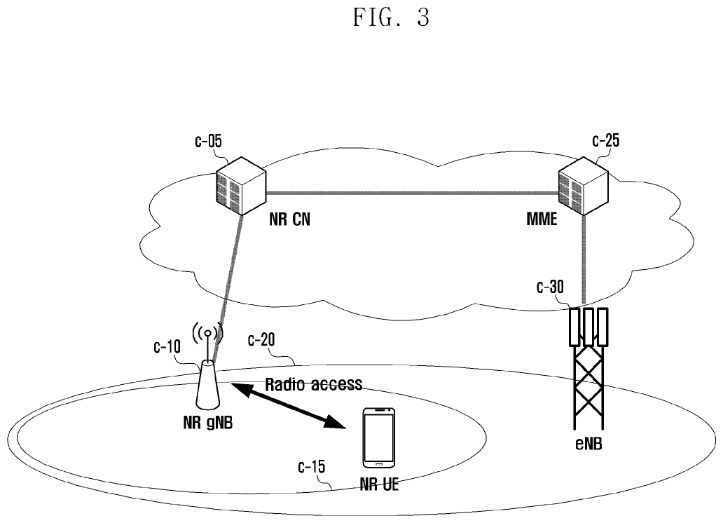

FIG. 3 illustrates a next-generation mobile communication system to which the disclosure is applicable.

Referring to FIG. 3, a radio access network of a next-generation mobile communication system (hereinafter NR or 5G) includes a next-generation base station (new radio node B, hereinafter NR gNB or NR base station) c-10, and a new radio core network (NR CN) c-05. A user terminal (new radio user equipment, hereinafter NR UE or NR terminal) c-15 accesses an external network via the NR gNB c-10 and the NR CN c-05.

In FIG. 3, the NR gNB c-10 corresponds to an evolved node B (eNB) of a conventional LTE system. The NR gNB c-10 is connected to the NR UE c-15 through a radio channel and may provide outstanding services as compared to a conventional node B. In the next-generation mobile communication system, since all user traffic including real-time services, such as voice over IP (VoIP) via the Internet protocol, is serviced through a shared channel, a device that collects state information, such as buffer states, available transmit power states, and channel states of UEs, and performs scheduling accordingly is required, and the NR gNB c-10 serves as the device. In general, one NR gNB controls multiple cells. In order to implement ultrahigh-speed data transfer beyond the current LTE, the next-generation mobile communication system may have a wider bandwidth than the existing maximum bandwidth, may employ an orthogonal frequency division multiplexing (hereinafter referred to as OFDM) as a radio access technology, and may additionally integrate a beamforming technology therewith. Furthermore, the next-generation mobile communication system employs an adaptive modulation & coding (hereinafter referred to as AMC) scheme for determining a modulation scheme and a channel coding rate according to a channel state of a UE. The NR CN c-05 performs functions such as mobility support, bearer configuration, and QoS configuration. The NR CN is a device responsible for various control functions as well as a mobility management function for a UE, and is connected to multiple base stations. In addition, the next-generation mobile communication system may interwork with the existing LTE system, and the NR CN may be connected to an MME c-25 via a network interface. The MME may be connected to an eNB c-30 that is an existing base station.

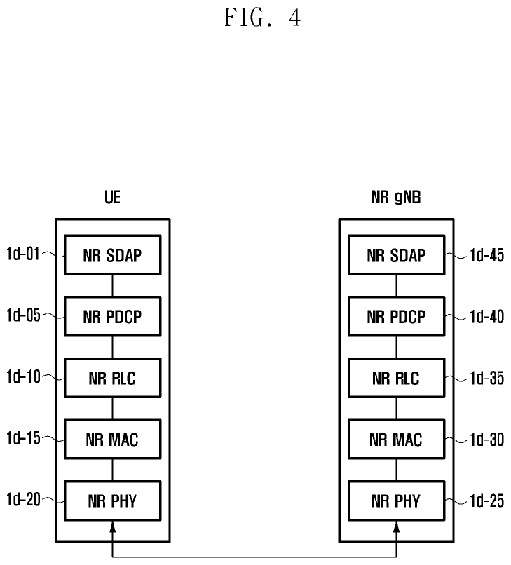

FIG. 4 illustrates a radio protocol structure of a next-generation mobile communication system to which the disclosure is applicable.

Referring to FIG. 4, a radio protocol of a next-generation mobile communication system includes an NR PDCP d-05 or d-40, an NR RLC d-10 or d-35, and an NR MAC d-15 or d-30 on each of UE and NR gNB sides. The main functions of the NR PDCP d-05 or d-40 may include some of functions below.
Header compression and decompression: ROHC only
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in uplink

The reordering of the NR PDCP device refers to a function of reordering PDCP PDU received from a lower layer in an order based on PDCP sequence numbers (SNs), and may include a function of transferring data to an upper layer according to a rearranged order, may include a function of directly transferring data without considering order, may include a function of rearranging order to record lost PDCP PDUs, may include a function of reporting the state of lost PDCP PDUs to a transmission side, or may include a function of requesting retransmission of lost PDCP PDUs.

The main functions of the NR RLC d-10 or d-35 may include some of functions below.
Transfer of upper layer PDUs
In-sequence delivery of upper layer PDUs
Out-of-sequence delivery of upper layer PDUs
Error Correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

The in-sequence delivery of the NR RLC device refers to a function of transferring RLC SDUs received from a lower layer to an upper layer in sequence, and may include a function of, if one original RLC SDU is divided into several RLC SDUs and then the RLC SDUs are received, reassembling the several RLC SDUs and transferring the reassembled RLC SDUs, may include a function of rearranging received RLC PDUs with reference to RLC sequence numbers (SNs) or PDCP sequence numbers (SNs), may include a function of rearranging order to record lost RLC PDUs, may include a function of reporting the state of lost RLC PDUs to a transmission side, may include a function of requesting retransmission of lost RLC PDUs, may include a function of, if there is a lost RLC SDU, sequentially transferring only RLC SDUs before the lost RLC SDU to an upper layer, may include a function of, although there is a lost RLC SDU, if a predetermined timer has expired, sequentially transferring, to an upper layer, all the RLC SDUs received before the timer is started, or may include a function of, although there is a lost RLC SDU, if a predetermined timer has expired, sequentially transferring all the RLC SDUs received up to the current, to an upper layer. In addition, the in-sequence delivery of the NR RLC device may include a function of processing RLC PDUs in the received order (regardless of the sequence number order, in the order of arrival) and delivering same to the PDCP device regardless of the order (out-of-sequence delivery), and may include a function of, in the case of segments, receiving segments which are stored in a buffer or which are to be received later, reconfiguring same into one complete RLC PDU, processing, and delivering same to the PDCP device. The NR RLC layer may include no concatenation function, which may be performed in the NR MAC layer or replaced with a multiplexing function of the NR MAC layer.

The out-of-sequence delivery of the NR RLC device refers to a function of instantly delivering RLC SDUs received from the lower layer to the upper layer regardless of the order, may include a function of, if multiple RLC SDUs received, into which one original RLC SDU has been segmented, are received, reassembling and delivering the same, and may include a function of storing the RLC SN or PDCP SN of received RLC PDUs, and recording RLC PDUs lost as a result of reordering.

The NR MAC d-15 or d-30 may be connected to multiple NR RLC layer devices configured in one UE, and the main functions of the NR MAC may include some of functions below.
Mapping between logical channels and transport channels
Multiplexing/demultiplexing of MAC SDUs
Scheduling information reporting
Error correction through HARQ
Priority handling between logical channels of one UE
Priority handling between UEs by means of dynamic scheduling
MBMS service identification
Transport format selection
Padding

An NR PHY layer d-20 or d-25 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer.

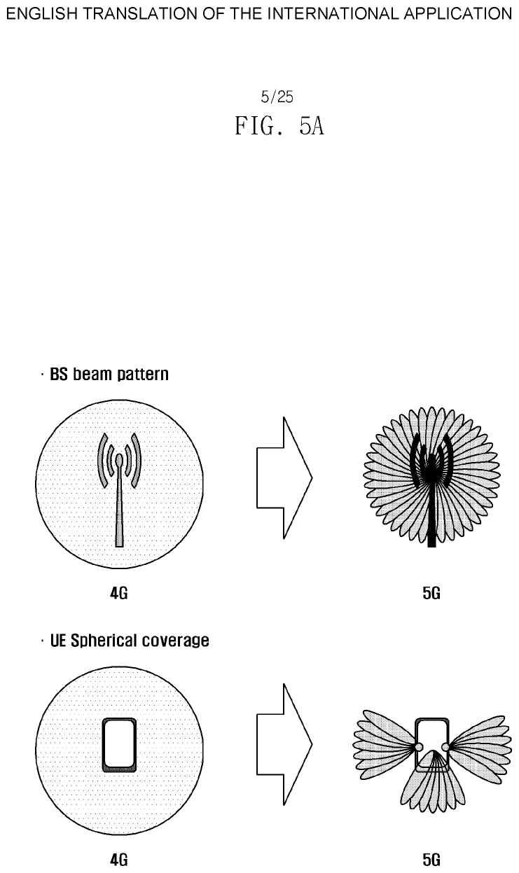

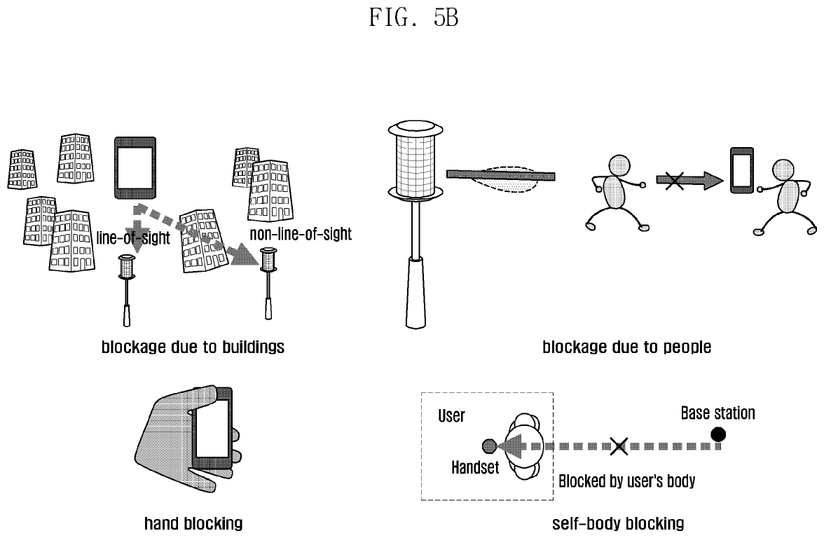

FIG. 5A illustrates signal patterns in respective wireless communication networks, and FIG. 5B illustrates communication situations in high-frequency areas.

In 4G communication (LTE) networks, beam patterns of a UE and a base station as illustrated in FIG. 5A may be considered, assuming operations in comparatively low frequency areas, and a circular or hexagonal coverage may be formed by an omni-antenna.

5G communication networks may operate across more expanded frequency areas, unlike LTE. For example, 5G wireless networks may operate in a first frequency range (FR1) defined so as to span 450 Mhz-7.125 GHz, and in FR2 defined so as to span 52.6 GHz. The FR2 band uses mmW, and beam patterns of a UE and a base station in a 5G communication network thus have small widths, as illustrated in FIG. 5A, due to the high degree of straightness, and emitting the same in specific directions may be considered. A high speed may be expected in the case of such mmW, but this situation is not preferred to the FR1 band because of low connectivity and coverage, and the base station's high capex. Accordingly, it may be considered to use 28 GHz bands for business-to-business (B2B) services, but it is difficult to use the same for general services for UEs.

In the case of 6G wireless networks, schemes such as a hybrid-beamforming system, a co-located cell, and non-standalone (NSA) for migration are being considered in relation to FR3, which corresponds to upper Mid-band (7-24 GHz), in order to solve the problems of small coverage and low connectivity of FR2, in addition to operating in THz frequency (for example, 140 GHz, 160 GHz, and the like) bands.

However, the closer to 28 GHz (mmW band), the more similarly to FR2 than FR1 FR3 areas operate. That is, the closer to high frequencies (for example, mmW bands), the stronger the straightness, thereby resulting in the effect of blockage by various obstacles in the coverage, as illustrated in FIG. 5B, or the effect of hand grip when the user holds the UE. This seriously affects the system performance (for example, temporary signal disconnection). Therefore, an improved beamforming system needs to be considered to improve the system performance.

Hereinafter, the disclosure proposes a communication method capable of improving user experiences and system performance while minimizing temporary signal disconnection. Hereinafter, in the disclosure, a method capable of supporting a connection to a UE and data communication in consideration of different signal characteristics of two base stations which use different frequency bands, based on an assumption that a beamforming system is operated in a non-standalone (NSA) situation, will be described with reference to the accompanying drawings.

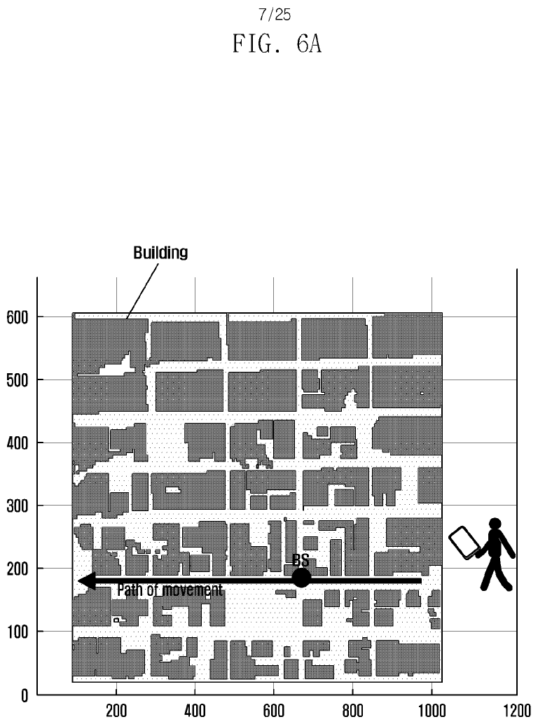

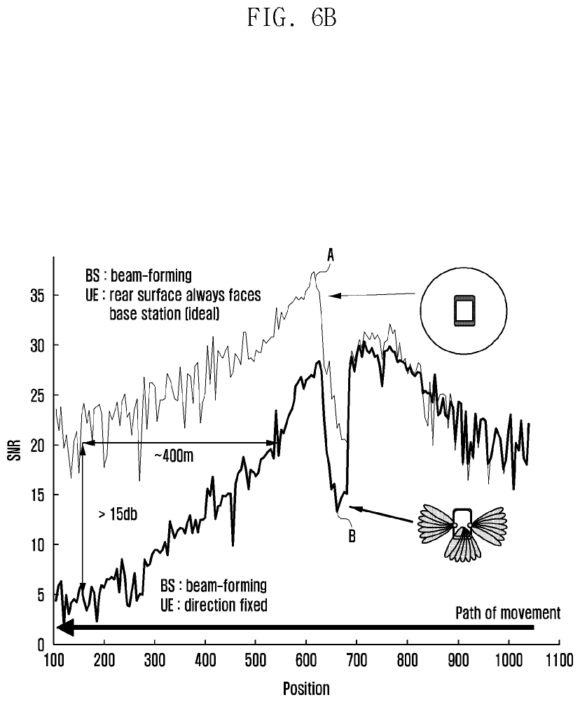

FIG. 6A illustrates an exemplary situation that may occur in a high-frequency area, and FIG. 6B illustrates a change in signal performance between a UE and a base station according to the exemplary situation in FIG. 6A.

Referring to FIG. 6A, according to an example, the user may grip his/her UE at the angle of about 45° and may move along the arrow (from the east to west). The UE's display faces the sky while lying at the angle of 45° while the user moves. Based on the scenario as in FIGS. 6A, 28 GHz ray-tracing simulation of the base station's beam performance is illustrated in FIG. 6B.

More specifically, it may be identified that, if the user moves to the spot labeled “base station (BS)” while gripping his/her UE, the UE's signal performance B described in terms of signal to noise ratio (SNR) is almost identical to the ideal performance A, as illustrated in FIG. 6B, as the user moves toward the BS. That is, the SNR increases linearly as the user comes closer to the BS.

In case that the user's position is almost identical to the position of the BS, the signal performance drops temporarily due to the coverage hole which occurs below the BS having a predetermined height. It may be identified that, if the user then moves away from the BS (toward the west), the ideal performance A shows a pattern similar to the case of the user's movement toward the BS (to the east), as illustrated in FIG. 6B, but the UE's signal performance B substantially drops. A maximum difference of 15 dB may be identified at the distance of about 400 m from the BS, even if the UE's spherical coverage performance is solely considered, without considering the blockage effect (that is, the user's body blocks signals). Based on such a scenario, more specific problem situations may be considered.

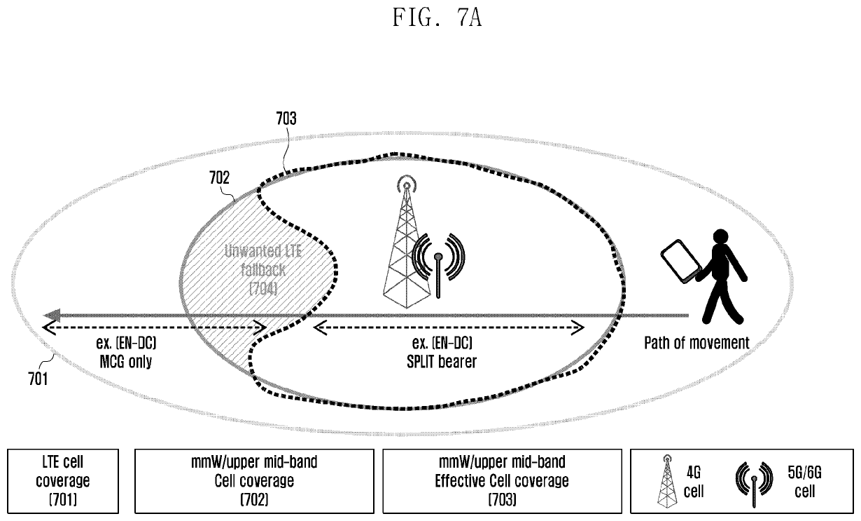

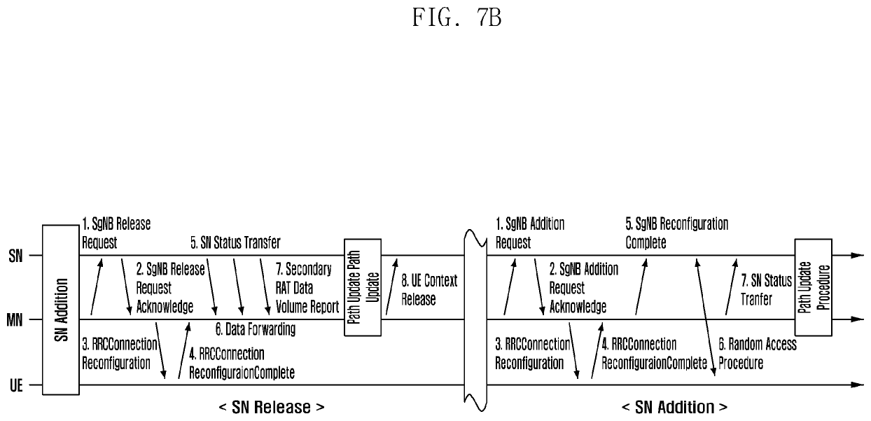

FIG. 7A illustrates a cell coverage according to an exemplary situation of the disclosure, and FIG. 7B illustrates a base station's connection support procedure based on the cell coverage in FIG. 7A.

FIG. 7A illustrates each base station's coverage in a circular shape, based on an assumption that a base station that uses an omni-antenna system (hereinafter, referred to as an LTE cell) and a base station that uses a beamforming system (hereinafter, referred to as a 5G/6G cell) are installed at the co-location, according to an example. It will be assumed in the following description of an embodiment of the disclosure that the two base stations are co-located, but the disclosure is not limited thereto.

Referring to FIG. 7A, the LTE cell may have the largest area of coverage 701, and the 5G/6G cell may have a smaller area of coverage 702. In this case, in the 5G/6G cell's coverage 702, communication may be supported for the UE in a dual-connectivity (DC) state of the LTE cell and the 5G/6G cell (that is, in NSA state). In this case, the effective coverage 703 defined in consideration of a general base station's coverage and the UE's spherical coverage may be illustrated in FIG. 7A as the dotted area.

The problem in that, in some situations, the signal performance drops drastically even in the coverage close to the base station, depending on the direction or state of the UE as the user moves. For example, in case that the user moves while gripping the UE in a direction as in FIG. 6A, the problem of abrupt signal performance drop occurs even through the UE is positioned sufficiently close to the 5G/6G cell due to various reasons such as the UE's spherical coverage, the base station's beam coverage, hand-grip effect, or self-blockage effect. Such an abrupt signal performance drop causes an unwanted fallback to the LTE cell, unlike the situation of handover performed because the signal performance drops in proportion to the distance from the base station.

In this case, the UE performs communication through a DC-based split bearer in the effective coverage 703. In case that the UE is out of the effective coverage 703 (for example, positioned in the marked area 704), the UE falls back to the LTE cell and performs communication while solely maintaining the connection to the master cell group (MCG).

Meanwhile, in case that a fallback to the LTE cell occurs, the procedure illustrated in FIG. 7B may be performed. In case that the UE's signal performance temporarily drops abruptly in the marked area 704 in FIG. 7A, the master node (MN) of DC (in the illustrated example, LTE base station or eNB) transmits an SgNB release request to the secondary node (SN) (in the illustrated example, 5G/6G base station or sgNB) as in FIG. 7B. If an SgNB release request acknowledgement (ACK) is received from the SN in response thereto, a message for SN connection release (RRC connection reconfiguration message) is transmitted to the UE. If a message indicating RRC connection reconfiguration completion is received from the UE, remaining procedures for SN release (data forwarding, path update procedure, and the like) are performed, and the SN connection is released. Thereafter, if the signal performance improves again according to the user's movement or the like, the MN performs a procedure for SN addition between the SN and the UE in order to reconfigure DC for the UE, and as illustrated in FIG. 7B, performs procedures for requesting SN addition, responding thereto, reconfiguring the RRC connection to the UE, path update, and the like such that a large amount of signaling is transmitted/received between nodes.

As described above, abrupt drops in signal performance occur for various reasons in spite of the sufficient proximity to the 5G/6G cell, and are difficult to predict or prevent. In addition, there is a high possibility of recovery, depending on the user's movement. Therefore, performing SN release and SN addition procedures every time the signal performance drops abruptly, as in the prior art, degrades user experiences because of the UE's temporary signal disconnection, and results in signaling overhead. Accordingly, the disclosure may provide a method for improving user experiences and system performance by reducing unwanted fallbacks to the LTE cell.

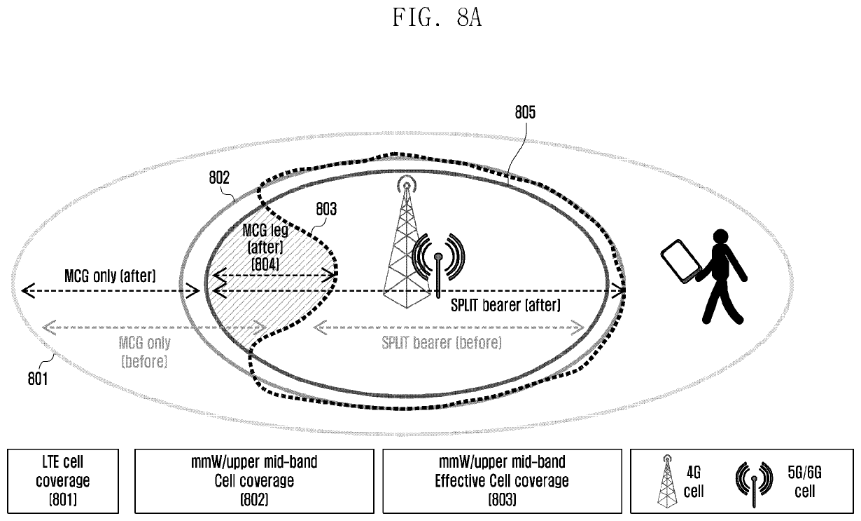

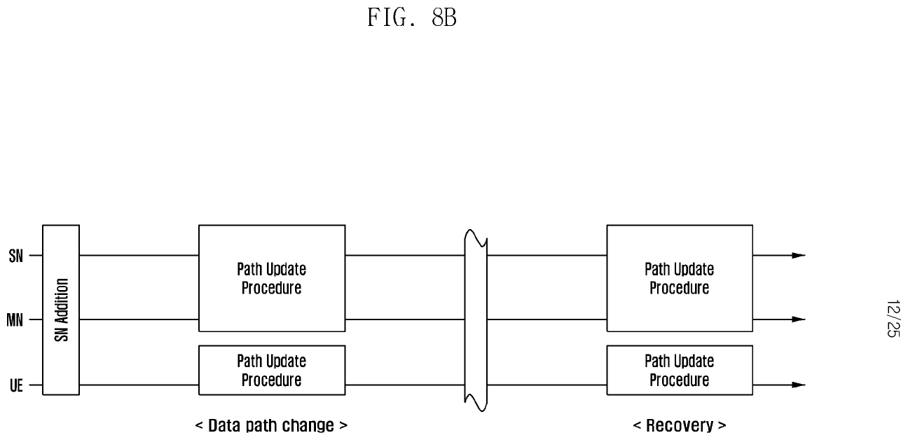

FIG. 8A illustrates a cell coverage according to an embodiment of the disclosure, and FIG. 8B illustrates a base station's connection support procedure, based on the cell coverage in FIG. 8A.

FIG. 8A illustrates a new coverage 805 proposed in the disclosure, in addition to the coverages 801 and 302 of respective cells and the effective coverage 803. The new coverage 805 refers to an area in which, if the signal performance falls abruptly, the connection to the 5G/6G cell needs to be maintained, without performing the SN release procedure as in the prior art.

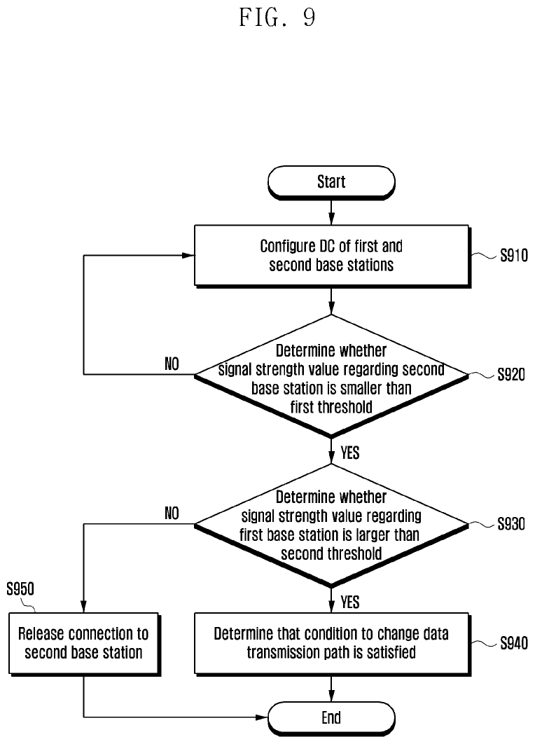

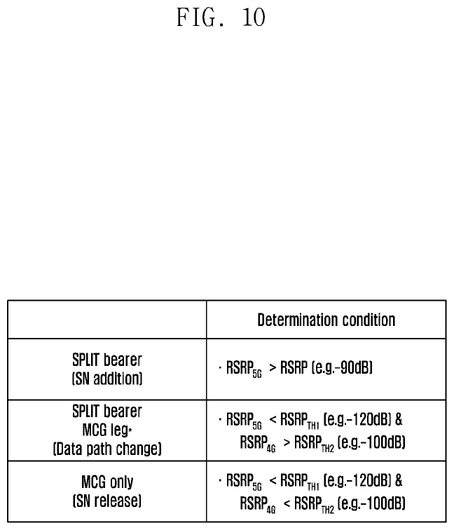

According to the disclosure, in case that the UE is in a specific position 804 inside the new coverage, although the UE is outside the effective coverage, the UE may perform communication without an unwanted fallback to the LTE cell. To this end, the disclosure proposes that a new criterion be added to determine whether the UE is in the area 804 in which the connection to the 5G/6G cell needs to be maintained, even if the signal performance is poor. The UE's operations in this regard will be described later in more detail with reference to FIG. 9 and FIG. 10.

Meanwhile, in an area inside the new coverage, in spite of an abrupt signal drop, the uplink/downlink data transmission/reception path may be solely changed to a path through the LTE cell while the connection to the 5G/6G cell is not released, thereby supporting data transmission/reception.

More specifically, as in FIG. 8B, after a connection to the 5G/6G cell is added to the UE (SN addition), and if the UE is positioned between the effective coverage and the new coverage, a data path change procedure may be performed such that the path of data related to the 5G/6G cell is changed to a path regarding the LTE cell, instead of performing the legacy SN release procedure. Accordingly, the UE performs communication through the split bearer in the effective coverage 803. In case that the UE is out of the effective coverage 803 but is positioned in a specific area 804 inside the newly defined coverage 805, the UE performs data communication through the MCG leg while maintaining the connection to the 5G/6G cell. Thereafter, the signal performance regarding the 5G/6G cell is recovered due to the user's movement, a change in the UE's direction, or the like, a data path change procedure may be performed to configure the previously change data transmission/reception path back to the path regarding the 5G/6G cell.

As such, the disclosure is advantageous in that, in a situation in which the signal performance regarding the 5G/6G cell temporarily drops due to the UE's spherical coverage characteristics or the like, a data path change procedure is supported, thereby guaranteeing the communication performance, and the problem of signaling overhead due to the SN release and addition procedures may be reduced. The disclosure is also advantageous in that, even in a situation in which the signal drops abruptly, the user does not experience any change in signal performance because the communication service is supported through a data path change, thereby improving user experiences.

FIG. 9 is a flowchart illustrating operations of a UE for determining conditions to change a data path according to an embodiment of the disclosure, and FIG. 10 illustrates determination conditions according to an embodiment of the disclosure. Hereinafter, the LTE cell will be referred to as a first base station, and the 5G/6G cell will be referred to as a second base station. Referring to FIG. 9, DC may be configured for the UE by the first and second base stations according to an embodiment of the disclosure (S910).

For example, the first base station may be configured the UE so as to measure the signal strength regarding the second base station, and the UE may report the result of measurement regarding the second base station to the first base station. As an example, if the first base station configures a threshold (for example, event B1 type) regarding measurement reporting, and if the reference signal received power (RSRP) measured with regard to the second base station is larger than the configured threshold, the UE reports the same to the first base station. The threshold, as used herein, is used to determine the condition to add a connection to the second base station to the UE, and may have a configured size of about −90 dB as illustrated in FIG. 10. Thereafter, the UE may receive a message for adding the second base station from the first base station.

The UE according to an embodiment of the disclosure may determine whether the signal strength value regarding the second base station is smaller than a first threshold not, in a state in which DC is configured (S920).

As described above, an embodiment of the disclosure additionally proposes predetermined threshold so as to determine a situation such as whether the UE is in the effective coverage, or whether the UE is positioned between the new coverage and the effective coverage. Firstly, a first threshold may be configured for the UE so as to determine whether the UE is out of the effective coverage. The first threshold is used to determine whether the signal performance regarding the second base station is degraded, may be configured to be event Al type, for example, and may have a configured size of about −100 dB as illustrated in FIG. 10.

In a state in which an additional connection to the second base station is configured, the UE may measure the signal strength value regarding the second base station periodically or in case that a preconfigured condition is satisfied, thereby determining whether the same becomes smaller than the first threshold or not.

As an example, in case that the signal strength value measured with regard to the second base station is larger than the first threshold, the UE transmits/receives data with the first and second base stations through the DC-configured split bearer because the signal connectivity regarding the second base station is acceptable (for example, positioned in the effective coverage).

In contrast, in case that the signal strength value regarding the second base station becomes smaller than the first threshold, the UE may determine whether the signal strength value regarding the first base station is larger than a second threshold (S930).

More specifically, in a state in which the signal performance regarding the second base station is degraded, the UE may additionally determine whether signal strength value regarding the first base station is acceptable. In order to determine this, the second threshold proposed in the disclosure may be configured to be event Al type, for example, and may have a configured size of about −120 dB as illustrated in FIG. 10. This is for the purpose of determining the signal strength value regarding the first base station which is co-located with the second base station, thereby determining that the connection to the second base station is worth maintaining according to the assumption that, if the signal strength is acceptable, the physical distance to the second base station will be small as well. However, the first and second base stations are not necessarily co-located as long as the threshold may be used as a condition to determine that the physical distance to the second base station is small.

Thereafter, upon determining that the signal strength value measured with regard to the first base station is larger than the second threshold, the UE may determine that the condition to change the data transmission path is satisfied (S940).

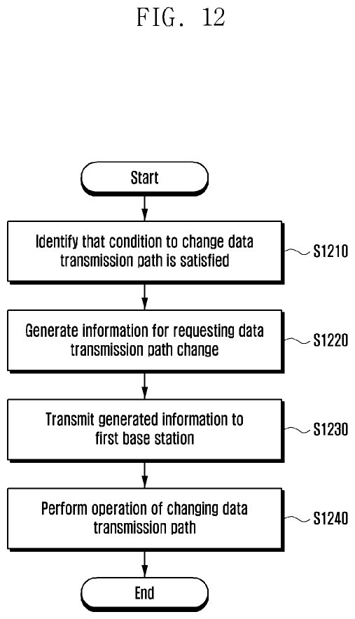

Upon determining that the condition to change the data transmission path is satisfied according to an example of the disclosure, the UE may initiate a procedure of requesting a data transmission path change. This will be described later with reference to FIG. 12.

If the data transmission path is changed, the UE may transmit/receive all uplink/downlink data with the first base station through the MCG leg while maintaining the structure of the split bearer.

Meanwhile, if the signal strength value regarding the first base station is not larger than the second threshold, the second base station's connection to the UE may be released (S950) according to the disclosure.

As an example, upon determining that the signal strength value regarding the first base station is smaller than the second threshold, the UE may report the same to the first base station, and the first base station may perform a procedure for releasing the second base station's connection to the UE (SN release procedure). This is because it has been deemed unnecessary to maintain the connection to the second base station, based on an assumption that the signal performance degradation regarding the second base station has not occurred in the physical vicinity of the second base station. If the connection to the second base station is released as such, only the bearer regarding the first base station is maintained (MCG only) in the split bearer structure, and data is transmitted/received with the first base station accordingly.

Although not illustrated in the drawings, the first and second thresholds described above may be configured for the UE by the first base station. As an example, the first base station may provide the UE with information regarding the first and second thresholds through a message (for example, RRCconnection reconfiguration message) for additionally configuring the connection to the second base station.

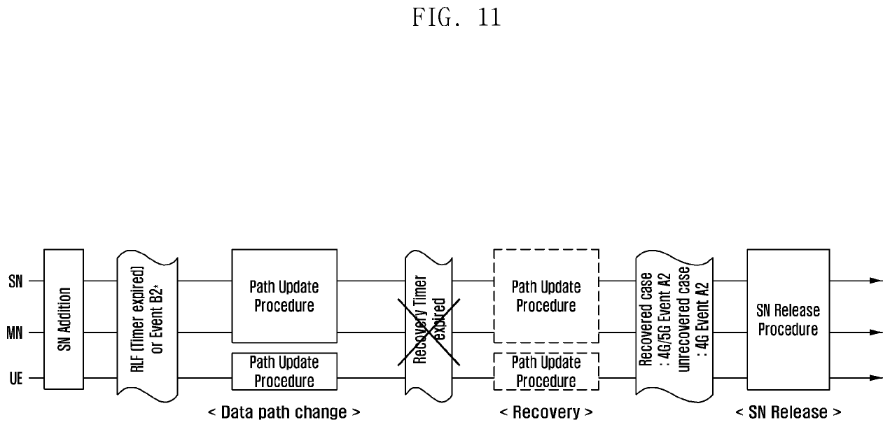

FIG. 11 illustrates a comparison between a data path change procedure proposed in the disclosure and a legacy procedure.

As illustrated in FIG. 11, in a situation in which DC is configured for first and second base stations, if the signal performance regarding the second base station is degraded by the occurrence of a radio link failure (RLF) or the like, the SN release procedure is instantly performed according to the prior art, or a data path change procedure is triggered. For example, if a data path change procedure is triggered, it is determined whether the signal performance regarding the second base station is recovered or not by driving a separate recovery timer or the like, thereby posing a problem in that, if the legacy procedure is followed, it is impossible to accurately determine whether the signal performance is recovered or not. That is, if the SN release procedure is performed with reference to timer expiration, for example, as in the legacy procedure, the situation cannot reflect whether the signal performance has recovered substantially.

However, the disclosure is advantageous in that thresholds are additionally configured as clear criteria of determination, thereby dealing with temporary signal performance degradation. Even if the data path change procedure is triggered, signal strength values regarding respective base stations are considered, thereby improving the accuracy in connection with determining whether the signal performance has recovered substantially, or whether the SN connection is to be released. In addition, signaling overhead due to unnecessary procedures is removed, thereby improving the user's communication experiences.

Hereinafter, a method for performing a data path change procedure according to an embodiment of the disclosure will be described in detail.

As described above, upon determining a situation of temporary signal performance degradation in relation to the second base station, the UE needs to provide the first base station with pertinent information in order to change the data transmission/reception path. For example, the UE needs to provide the first base station with signal strength values measured with regard to the first and second base stations, or the result of comparison with thresholds. However, the disclosure may provide a method in which the UE sends a request for data path change to a base station such that additional signaling for the data path change, such as the UE's information provision and the base station's reconfiguration, can be minimized.

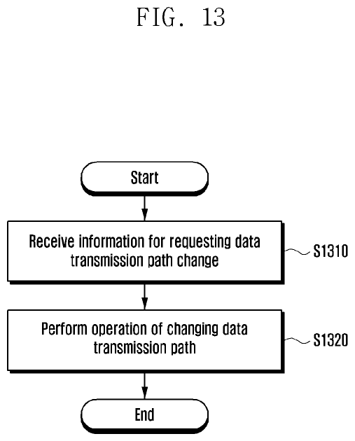

FIG. 12 is a flowchart illustrating operations of a UE for a data path change according to an embodiment of the disclosure, and FIG. 13 is a flowchart illustrating operations of a base station for a data path change according to an embodiment of the disclosure.

Referring to FIG. 12, the UE according to an embodiment of the disclosure may identify whether a condition to change a data transmission path is satisfied in a state in which DC is configured (S1210).

The condition to change a data transmission path may be determined, while performing data communication through a split bearer as described above, based on the signal strength value regarding the second base station being smaller than a first threshold, and the signal strength value regarding the first base station being larger than a second threshold.

If the condition to change a data transmission path is satisfied as described above, the UE according to an embodiment of the disclosure may generate information for requesting a data transmission path change (S1220), and may transmit the generated information to the first base station (S1230).

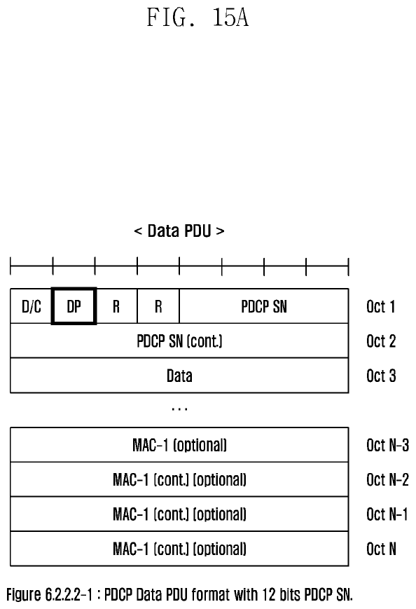

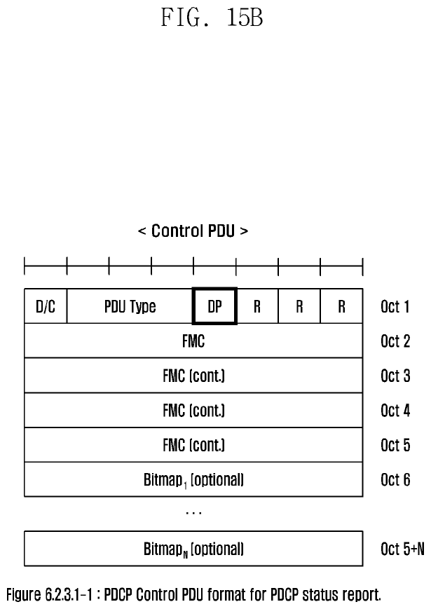

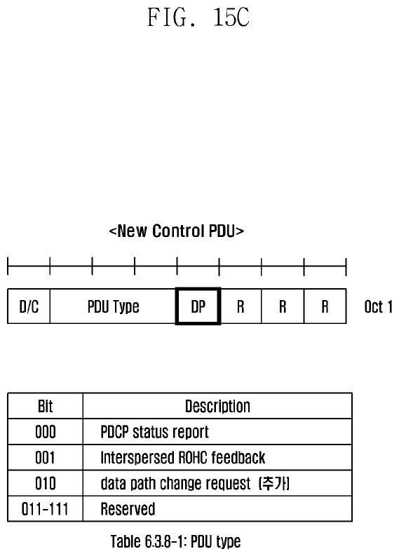

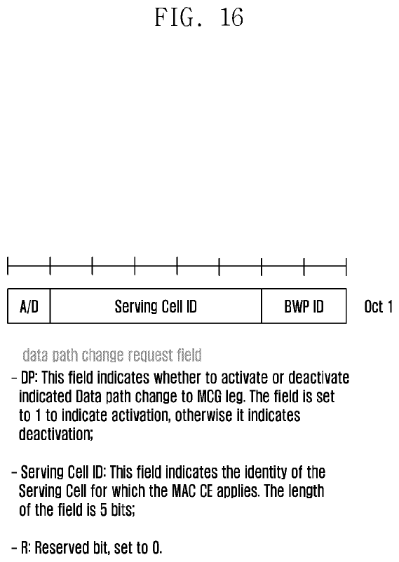

The UE according to an embodiment of the disclosure may request a data transmission path change by using data transmitted to the first base station, instead of separate signaling. For example, the UE according to an embodiment of the disclosure may use a predetermined size of bit value within data transmitted to the first base station so as to indicate whether a data transmission path change is activated or not, to the base station. Detailed examples regarding the structure of data for requesting a data transmission path change will be described later with reference to FIG. 15A to FIG. 16.

After transmitting information for requesting a data transmission path change as described above, the UE may perform an operation of changing the data transmission path with the first base station (S1240).

The operation of changing the data transmission path refers to an operation in which data related to the second base station is transmitted/received between the first base station and the UE such that downlink data to be transmitted from the second base station to the UE is transmitted from the first base station to the UE, and uplink data to be transmitted from the UE to the second base station is transmitted from the UE to the first base station.

The operation of changing the data transmission path may be performed based on a request for a data transmission path change sent from the UE to a base station. For example, the UE may transmit information for requesting a data transmission path change to the first base station and may then instantly transmit uplink data to be transmitted to the second base station to the first base station. The UE according to an embodiment of the disclosure may also receive downlink data relates to the second base station from the first base station, based on uplink data transmission. In case that the operation of changing the data transmission path is performed as described above, the signaling overhead may be minimized because no additional configuration or signaling by the base station is separately involved.

As another example, the operation of changing the data transmission path may be performed based on the UE transmitting information for requesting a data transmission path change to the first base station, and the first base station transmitting a confirmation response or message regarding thereto to the UE. For example, in case that the UE according to an embodiment of the disclosure transmits information for requesting a data transmission path change to the first base station and then receives a confirmation response or message regarding the data transmission path from the first base station, the UE may transmit uplink data related to the second base station to the first base station. The confirmation response or message may be explicitly indicated through an acknowledgement (ACK) regarding data including information for requesting a data transmission path change, for example, or may be indicated implicitly as in an operation in which the first base station transmits downlink data related to the second base station to the UE. In case that the operation of changing the data transmission path is performed as described above, the first base station identifies the data transmission path change, thereby clarifying the timepoint at which data related to the second base station is transmitted/received between the same and the first base station.

Referring to FIG. 13, the base station according to an embodiment of the disclosure may receive information for requesting a data transmission path change from a UE (S1310).

Although not illustrated in the drawings, the first base station according to an embodiment of the disclosure may configure thresholds for the UE as criteria for determining a condition to change the data transmission path with regard to the UE. The thresholds may be provided to the UE in a process of configuration information for measurement reporting is provided to the UE, or an additional connection to the second base station is configured. The information for requesting a data transmission path change may be received from the UE, based on the thresholds configured by the first base station.

Upon receiving the information for requesting a data transmission path change from the UE, the first base station according to an embodiment of the disclosure may perform an operation of changing the data transmission path between the same and the UE (S1320).

As described above with reference to FIG. 12, the operation of changing the data transmission path may be performed based on the UE transmitting a request for a data transmission path change to the first base station. In this case, the first base station according to an embodiment of the disclosure may determine that the operation of changing the data transmission path has been triggered by receiving the information from the UE, and may expect that uplink data related to the second base station will be received from the UE. Thereafter, if uplink data related to the second base station is received, downlink data to be transmitted from the second base station to the UE may be transmitted to the UE through the MCG bearer regarding the first base station.

As another example, the operation of changing the data transmission path may be performed based on the first base station receiving information for requesting a data transmission path change from the UE and then transmitting information for a confirmation response regarding thereto to the UE. If information for requesting a data transmission path change is included in data and then transmitted, the first base station according to an example of the disclosure may generate ACK information indicating successful reception of the data and then transmit the same to the UE. As such, the first base station may transmit a response to the UE to approve the request regarding the data transmission path. Thereafter, the first base station may receive uplink data related to the second base station, based thereon.

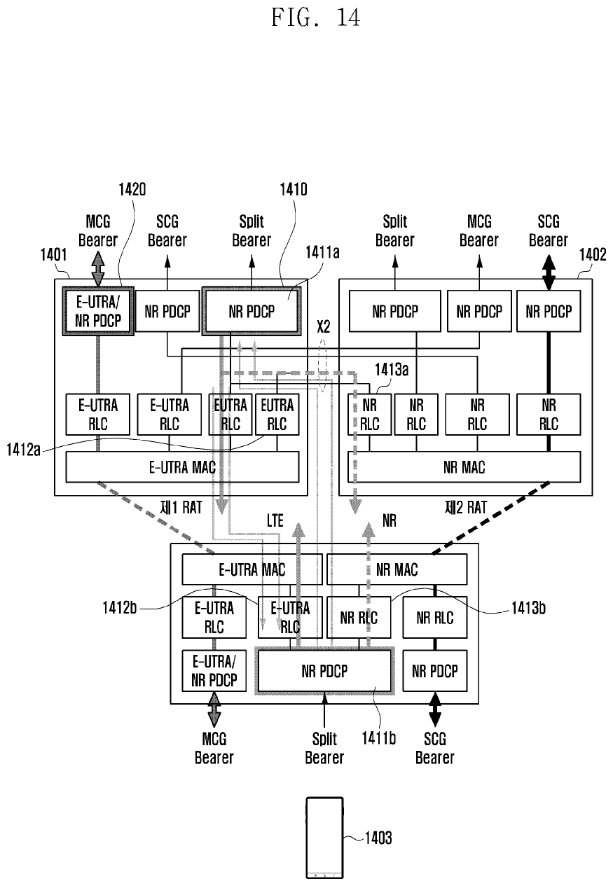

FIG. 14 illustrates a data transmission path in connection with a bearer structure according to an embodiment of the disclosure.

FIG. 14 will be described based on an NSA situation (for example, EN-DC) in case that the first base station 1401 configured to perform communication based on a first radio access technology (RAT) (for example, LTE) and a second base station 1402 which uses a second RAT (for example, 5G/6G) have DC configurations with regard to the UE 1403.

If an additional connection to the second base station 1402 is configured for the UE 1403, the PDCP entity 1411a of the first base station 1401 may configure a split bearer with the RLC entity 1412a of the first base station and the RLC entity 1413a of the second base station, thereby transmitting downlink data to the UE 1403 through each of the RLC entity 1412a of the first base station and the RLC entity 1413a of the second base station. In addition, the UE 1403 may transmit uplink data regarding the first base station 1401 through the RLC entity 1412b of the first RAT connected to the PDCP entity 1411b, and may transmit uplink data regarding the second base station 1402 through the RLC entity 1413b of the second RAT connected to the PDCP entity 1411b.

Thereafter, if the condition to change the data transmission path according to an embodiment of the disclosure is satisfied, the UE 1403 may transmit information for requesting data transmission path change to the first base station 1401. The UE 1403 according to an embodiment of the disclosure may transmit uplink data regarding the first base station 1401 and uplink data regarding the second base station 1402 all through the RLC entity 1412b of the first RAT. The data may be transmitted only through the bearer related to the first base station 1401 while the split bearer's structure is maintained.

Upon receiving the information for requesting data transmission path change from the UE 1403, the first base station 1401 according to an embodiment of the disclosure may determine that uplink data regarding each of the first base station 1401 and the second base station 1402 will be received through the RLC entity 1412a of the first base station. In addition, the first base station 1401 may control not only downlink data to be transmitted through the RLC entity 1412a of the first base station, but also downlink data to be transmitted through the RLC entity 1413a of the second base station, which is connected by the X2 interface, so as to be transmitted to the UE 1403 through the RLC entity 1412a of the first base station. Likewise, data may be continuously transmitted/received through the first base station 1401 between the UE 1403 and the first base station 1401 while the split bearer structure is maintained until a condition for SN release is identified.

Thereafter, upon receiving a report indicating the signal measurement value regarding the first base station 1401 has dropped below a predetermined threshold, from the UE 1403, the first base station 1401 may perform an SN release procedure. Accordingly, communication is performed between the UE 1403 and the first base station 1401 through the bearer structure (MCG bearer) 1420 prior to the configuration of the split bearer.

FIG. 15A illustrates the structure of a PDCP data PDU for requesting a data transmission path change according to an example of the disclosure. FIG. 15B illustrates the structure of a PDCP control PDU for requesting a data transmission path change according to an example of the disclosure. FIG. 15C illustrates the structure of a new PDCP control PDU for requesting a data transmission path change according to an example of the disclosure. FIG. 16 illustrates the structure of a MAC CE for requesting a data transmission path change according to an example of the disclosure.

In the case of DC, branching of data is performed by a PDCP entity, and a scheme may be considered so as to request data transmission path change through a PDCP protocol data unit (PDU). FIG. 15A to FIG. 15C illustrate cases in which a data transmission path change request according to an example of the disclosure is transmitted through a PDCP PDU.

Referring to FIG. 15A, information regarding a data transmission path change request may be included in a PDCP data PDU according to an example of the disclosure. The value of the reserved bit (one bit) of the PDCP data PDU may be used in this regard. The UE according to an example of the disclosure may indicate whether a data transmission path change is activated or not, by using the corresponding bit value (data path change (DP))

For example, the corresponding bit may have a configured value of 1 to indicate activation of a data transmission path change from the split bearer structure to the MCG leg, or may have a configured value of 0 to indicate deactivation of a data transmission path change. Indication of deactivation may be used to request to request changing the existing MCG leg back to the split bearer structure, for example. The remaining reserved bit may be configured to be 0.

In addition, as illustrated in FIG. 15B, information regarding a data transmission path change request may be included in a PDCP control PDU according to an example of the disclosure. As described above with reference to FIG. 15A, the reserved bit of the first octet may be used to indicate whether a data transmission path change is activated or not, and the reserved bit of the status report used for a handover according to the prior art may be used in this regard.

FIG. 15C illustrates the structure of a newly defined PDCP control PDU. As in FIG. 15C, a new PDCP control PDU's structure may be proposed according to an example of the disclosure. In this case, as illustrated in FIG. 15C, a specific bit value may be predefined and configured to indicate a data transmission path change.

Meanwhile, in addition to PCDP packets, a MAC control element (CE) may also be used to request a data transmission path change according to an example of the disclosure. Referring to FIG. 16, together with a field value that indicates the corresponding serving cell's ID and a field value that indicates the BWP ID, the structure of a MAC CE including a field for indicating a data path change may be considered. In this case, the activation/deactivation (A/D) field may be used to indicate whether a data path change is activated or not. Similarly to the example of the PDCP described above, the configured value of 1 may indicate activation, and configured value of 9 may indicate deactivation.

Although not illustrated in the drawings, a data transmission path change may be requested by using uplink control information (UCI) in consideration of a situation in which channels change quickly. For example, a specific format's preconfigured field may be used to indicate whether a data transmission path change is activated or not.

In addition, although operations of changing the data transmission path so as to activate only the MCG leg in a temporary situation of an abrupt signal drop, a scheme may also be considered to transmit the same data by activating the PDCP duplication function, thereby preventing communication performance degradation. For example, it may be considered to add the condition to change a data transmission path described above in the disclosure, as a condition to activate the PDCP duplication.

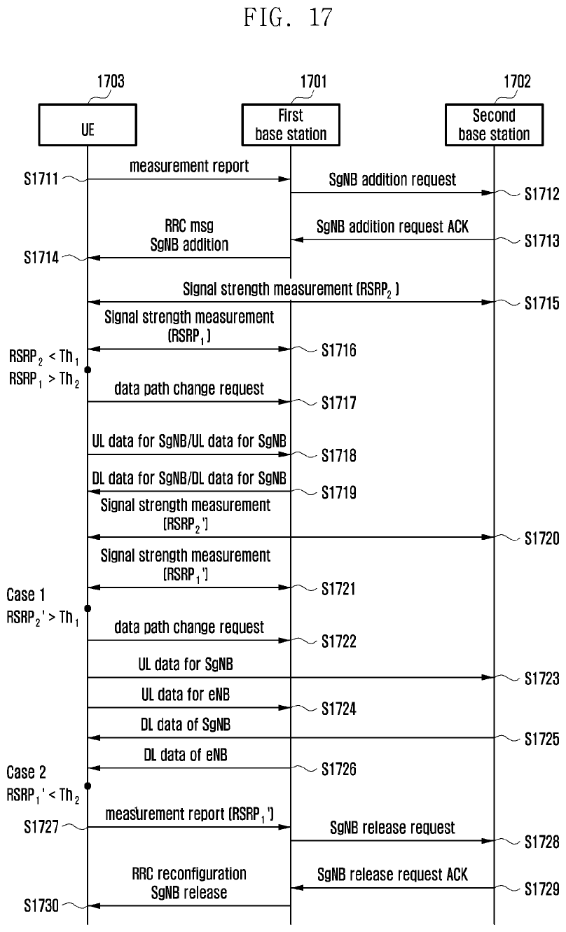

FIG. 17 illustrates the entire operations according to an example of the disclosure.

Referring to FIG. 17, the UE 1703 may measure the signal strength regarding the second base station 1702, based on configurations of the first base station 1701 or the like, and may report the measurement result to the first base station 1701 (S1711). The first base station 1701 may determine DC configurations with the second base station 1702, based on the measurement report received from the UE 1703, and may transmit an addition request message to the second base station 1702 (S1712). Upon receiving a response thereto from the second base station 1702 (S1713), the first base station 1701 may transmit a message for adding/configuring the second base station 1702 to the UE 1703 (S1714).

In a state in which DC is configured, the UE 1703 may perform measurement operations according to an example of the disclosure by using thresholds configured by the first base station 1701. More specifically, the UE 1703 may measure the signal strength (RSRP₂) regarding the second base station 1702 (S1715), and may determine whether the signal strength value (RSRP₂) has become smaller than the configured first threshold (Th₁). Upon determining that the signal strength value (RSRP₂) is smaller than the configured first threshold (Th₁), the UE 1703 may measure the signal strength (RSRP₁) regarding the first base station 1701 (S1716). Upon determining that the signal strength value (RSRP₁) regarding the first base station 1701 is larger than the configured second threshold (Th₂), the UE 1703 may determine that the condition to change the data transmission path is satisfied.

The UE 1703 may generate information for requesting a data path change and transmit the same to the first base station 1701 such that data related to the second base station 1702 can be transmitted/received through the MCG leg regarding the first base station 1701 (S1717). Based on transmitting the information according to an example of the disclosure, the UE 1703 may transmit/receive data related to the second base station 1702 between the same and the first base station 1701. That is, the UE 1703 may transmit uplink data regarding the second base station 1702 and uplink data regarding the first base station 1701 all to the first base station 1701 (S1718), and may receive downlink data of the second base station 1702 and downlink data of the first base station 1701 all from the first base station 1701 (S1719).

Thereafter, the UE 1703 may measure the signal strength value regarding the second base station 1702 (S1720) so as to determine whether the same becomes larger than the first threshold (Th₁). In case 1 in which the signal strength value (RSRP₂′) measured again with regard to the second base station 1702 becomes larger than the preconfigured first threshold (Th₁), the UE 1703 may transmit information for requesting an additional data transmission path change to the first base station 1701 (S1722). Based on the information transmission, the UE may transmit uplink data regarding the second base station 1702 to the second base station 1702 (S1723) through a split bearer, and may transmit uplink data regarding the first base station 1701 to the first base station 1701 (S1724). Likewise, downlink data regarding the UE 1703 may be transmitted to the UE through each of the first base station 1701 and the second base station 1702 (S1725 and S1726).

To the contrary, in case 2 in which the signal strength value (RSRP₂′) measured again with regard to the second base station 1702 is still smaller than the first threshold (Th₁) (S1721), the signal strength value (RSRP₁′) regarding the first base station may be measured, thereby determining whether the same is larger than the second threshold (Th₂). If the signal strength value (RSRP₁′) measured with regard to the first base station 1701 becomes smaller than the second threshold (Th₂), the UE 1703 may report the pertinent measurement value (RSRP₁′) to the first base station 1701 (S1727). The first base station 1701 may determine to release the connection of the second base station 1702, based on the measurement report from the UE 1703. Therefore, the first base station 1701 transmits a connection release request to the second base station 1702 (S1728). Upon receiving a response thereto from the second base station 1702 (S1729), the first base station 1701 transmits a message for configuring release of the connection regarding the second base station 1702 to the UE 1703 (S1730). Accordingly, only the bearer between the first base station 1701 and the UE 1703 is maintained.

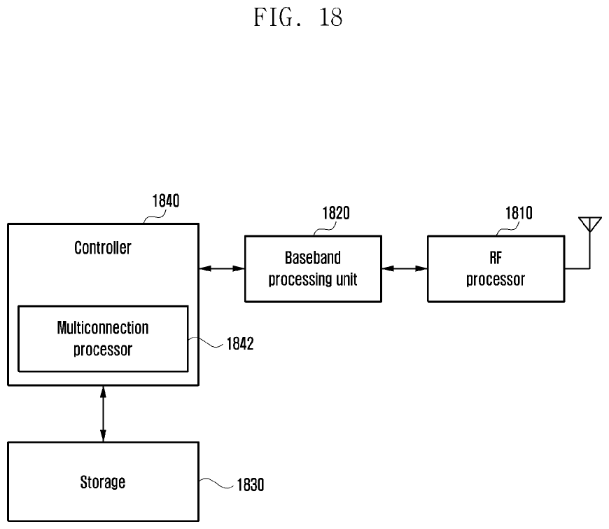

FIG. 18 is a block diagram illustrating a structure of a UE to which the disclosure is applicable. Referring to FIG. 18, the UE may include a radio frequency (RF) processor 1810, a baseband processor 1820, a storage 1830, and a controller 1840.

The RF processor 1810 may perform functions for transmitting/receiving signals through a radio channel, such as signal band conversion and amplification. That is, the RF processor 1810 may up-convert a baseband signal provided from the baseband processor 1820 to an RF band signal, may transmit the same through an antenna, and may down-convert an RF band signal received through the antenna to a baseband signal. For example, the RF processor 1810 may include a transmission filter, a reception filter, an amplifier, a mixer, an oscillator, a digital-to-analog converter (DAC), an analog-to-digital converter (ADC), and the like. Although only one antenna is illustrated in the drawing, the UE may include multiple antennas. In addition, the RF processor 1810 may include multiple RF chains. Furthermore, the RF processor 1810 may perform beamforming. For the beamforming, the RF processor 1810 may adjust the phase and magnitude of signals transmitted/received through multiple antennas or antenna elements, respectively. In addition, the RF processor may perform MIMO, and may receive multiple layers when performing a MIMO operation. The RF processor 1810 may appropriately configure multiple antennas or antenna elements to perform reception beam sweeping or may adjust the direction and beam width of a reception beam so as to resonate the reception beam with a transmission beam under the control of the controller.

The baseband processor 1820 may perform functions of conversion between baseband signals and bitstrings according to the system's physical layer specifications. For example, in case of data transmission, the baseband processor 1820 may encode and modulate a transmitted bitstring to generate complex symbols. In addition, in case of data reception, the baseband processor 1820 may demodulate and decode a baseband signal provided from the RF processor 1810 to restore a received bitstring. For example, when following the orthogonal frequency division multiplexing (OFDM) scheme, during data transmission, the baseband processor 1820 may encode and modulate a transmitted bitstring to generate complex symbols, may map the complex symbols to subcarriers, and may configure OFDM symbols through inverse fast Fourier transform (IFFT) operation and cyclic prefix (CP) insertion. In addition, during data reception, the baseband processor 1820 may split a baseband signal provided from the RF processor 1810 at the OFDM symbol level, may restore signals mapped to subcarriers through a fast Fourier transform (FFT) operation, and may restore a received bitstring through demodulation and decoding.

The baseband processor 1820 and the RF processor 1810 transmit and receive signals as described above. Therefore, the baseband processor 1820 and the RF processor 1810 may be referred to as a transmitter, a receiver, a transceiver, or a communication unit. Furthermore, at least one of the baseband processor 1820 and the RF processor 1810 may include multiple communication modules to support multiple different radio access technologies. In addition, at least one of the baseband processor 1820 and the RF processor 1810 may include different communication modules to process signals in different frequency bands. For example, the different radio access technologies may include LTE networks, NR networks, etc. Also, the different frequency bands may include super high frequency (SHF) bands (e.g., 2.5 GHz or 5 GHz bands), millimeter wave (mmWave) bands (e.g., 38 GHz or 60 GHz bands), and the like, The storage unit 1830 may store data such as basic programs for operation of the UE, application programs, and configuration information. In addition, the storage 1830 may provide the stored data at the request of the controller 1840.

The controller 1840 controls the overall operation of the UE. For example, the controller 1840 may transmit/receive signals through the baseband processor 1820 and the RF processor 1810. In addition, the controller 1840 records data in the storage 1830 and reads the data from the storage 1130. To this end, the controller 1840 may include at least one processor. For example, the controller 1840 may include a communication processor (CP) configured to perform control for communication, and an application processor (AP) configured to control upper layers such as application programs.

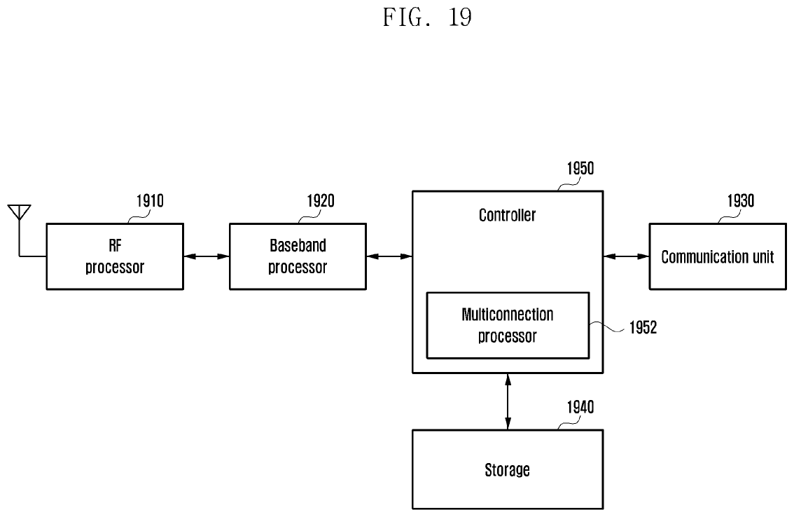

FIG. 19 is a block diagram illustrating a structure of a base station according to an embodiment of the disclosure.

Referring to FIG. 19, the base station may include an RF processor 1910, a baseband processor 1920, a backhaul communication unit 1930, a storage 1940, and a controller 1950.

The RF processor 1910 may perform functions for transmitting/receiving signals through a radio channel, such as signal band conversion and amplification. That is, the RF processor 1910 may up-convert a baseband signal provided from the baseband processor 1920 to an RF band signal, may transmit the same through an antenna, and may down-convert an RF band signal received through the antenna to a baseband signal. For example, the RF processor 1910 may include a transmission filter, a reception filter, an amplifier, a mixer, an oscillator, a DAC, and an ADC. Although only one antenna is illustrated in the drawing, the first access node may include multiple antennas. In addition, the RF processor 1910 may include multiple RF chains. Furthermore, the RF processor 1910 may perform beamforming. For the beamforming, the RF processor 1910 may adjust the phase and magnitude of signals transmitted/received through multiple antennas or antenna elements, respectively. The RF processor may transmit one or more layers to perform a downward MIMO operation.

The baseband processor 1920 may perform functions of conversion between baseband signals and bitstrings according to the physical layer specifications of first radio access technology. For example, in case of data transmission, the baseband processor 1920 may encode and modulate a transmitted bitstring to generate complex symbols. In addition, in case of data reception, the baseband processor 1920 may demodulate and decode a baseband signal provided from the RF processor 1910 to restore a received bitstring. For example, when following the OFDM scheme, during data transmission, the baseband processor 1920 may encode and modulate a transmitted bitstring to generate complex symbols, may map the complex symbols to subcarriers, and may configure OFDM symbols through IFFT operation and CP insertion. In addition, during data reception, the baseband processor 1920 may split a baseband signal provided from the RF processor 1910 at the OFDM symbol level, may restore signals mapped to subcarriers through FFT operation, and may restore a received bitstring through demodulation and decoding. The baseband processor 1920 and the RF processor 1910 transmit and receive signals as described above. Therefore, the baseband processor 1920 and the RF processor 1910 may be referred to as a transmitter, a receiver, a transceiver, or a communication unit.

The backhaul communication unit 1930 provides an interface for communicating with other nodes in the network.

The storage 1940 may store data such as basic programs for operation of the main base station, application programs, and configuration information. Particularly, the storage 1940 may store information regarding a bearer allocated to a connected UE, a measurement result reported from the connected UE, and the like. In addition, the storage 1940 may store information serving as a reference to determine whether to provide multi-connection to a UE or to suspend the same. In addition, the storage 1940 may provide the stored data at the request of the controller 1950.

The controller 1950 controls the overall operation of the main base station. For example, the controller 1950 transmits/receives signals through the baseband processor 1920 and the RF processor 1910 or through the backhaul communication unit 1930. In addition, the controller 1950 records data in the storage unit 1940 and reads the data from the storage unit 1940. To this end, the controller 1950 may include at least one processor.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

1. A method performed by a terminal in a wireless communication system, the method comprising:
identifying whether a condition to change a transmission path of data for a second base station of a second radio access technology (RAT) to a transmission path for a first base station of a first RAT is satisfied, a dual connectivity (DC) being configured for the second base station with the first base station;
in case that the condition is satisfied, generating information for requesting to change a data transmission path; and
transmitting, to the first base station, the generated information.

2. The method of claim 1,
wherein the information is transmitted by one of a packet data convergence protocol (PDCP) packet, a medium access control (MAC) control element (CE), or uplink control information (UCI), and
wherein, in case that the information is transmitted by the PDCP packet or the MAC CE, the information includes a bit value indicating whether to activate the change of the data transmission path.

3. The method of claim 1, further comprising:
receiving, from the first base station, threshold information including a first threshold value and a second threshold value,
wherein the identifying whether the condition is satisfied comprises:
identifying whether a signal strength value for the second base station is smaller than the first threshold value;
in case that the signal strength value for the second base station is smaller than the first threshold value, identifying whether a signal strength value for the first base station is larger than the second threshold value; and
in case that the signal strength value for the first base station is larger than the second threshold value, determining that the condition is satisfied.

4. The method of claim 3, further comprising:
transmitting, to the first base station, uplink data associated with the second base station based on a transmission of the generated information; and
receiving, from the first base station, downlink data associated with the second base station.

5. The method of claim 4, further comprising:
measuring a value of signal strength for the first base station;
identifying whether the measured value is smaller than the second threshold value;
in case that the measured value is smaller than the second threshold value, transmitting, to the first base station, a report including the measured value; and
receiving, from the first base station, a message for configuring release of a connection to the second base station based on the report.

6. A method performed by a first base station in a wireless communication system, the method comprising:
receiving, from a terminal, information for requesting to change a transmission path of data for a second base station of second radio access technology (RAT) to a transmission path for a first base station of a first RAT, a dual connectivity (DC) being configured for the second base station with the first base station;
receiving, from the terminal, uplink data associated with the second base station, based on the information; and
transmitting, to the terminal, downlink data associated with the second base station.

7. The method of claim 6,
wherein the information is received by one of a packet data convergence protocol (PDCP) packet, a medium access control (MAC) control element (CE), or uplink control information (UCI), and
wherein, in case that the information is received by the PDCP packet or the MAC CE, the information includes a bit value indicating whether to activate the change of the data transmission path.

8. The method of claim 6, further comprising:
transmitting, to the terminal, threshold information including a first threshold value related to the second base station and a second threshold value related to the first base station;
receiving, from the terminal, a report including a measured value of a signal for the first base station, based on a state in which the transmission path of the data for the second base station is changed; and
transmitting, to the terminal, a message for configuring release of a connection to the second base station, based on the measured value being smaller than the second threshold value.

9. A terminal in a wireless communication system, the terminal comprising:
a transceiver; and
a controller configured to:
identify whether a condition to change a transmission path of data for a second base station of a second radio access technology (RAT) to a transmission path for a first base station of a first RAT is satisfied, a dual connectivity (DC) being configured for the second base station with the first base station,
in case that the condition is satisfied, generate information for requesting to change a data transmission path, and
control the transceiver to transmit, to the first base station, the generated information.

10. The terminal of claim 9,
wherein the information is transmitted by one of a packet data convergence protocol (PDCP) packet, a medium access control (MAC) control element (CE), or uplink control information (UCI), and
wherein, in case that the information is transmitted by the PDCP packet or the MAC CE, the information includes a bit value indicating whether to activate the change of the data transmission path.

11. The terminal of claim 10, wherein the controller is configured to:
control the transceiver to receive, from the first base station, threshold information including a first threshold value and a second threshold value;
identify whether a signal strength value for the second base station is smaller than the first threshold value;
in case that the signal strength value for the second base station is smaller than the first threshold value, identify whether a signal strength value for the first base station is larger than the second threshold value;
in case that the signal strength value for the first base station is larger than the second threshold value, determine that the condition is satisfied;
control the transceiver to transmit, to the first base station, uplink data associated with the second base station based on a transmission of the generated information; and
control the transceiver so as to receive, from the first base station, downlink data associated with the second base station.

12. The terminal of claim 11, wherein the controller is configured to:
measure a value of signal strength for the first base station;
identify whether the measured value is smaller than the second threshold value;
in case that the measured value is smaller than the second threshold value, control the transceiver so as to transmit, to the first base station, a report including the measured value; and
control the transceiver to receive, from the first base station, a message for configuring release of a connection to the second base station based on the report.

13. A first base station in a wireless communication system, the first base station comprising:
a transceiver; and
a controller configured to:
control the transceiver so as to receive, from a terminal, information for requesting to change a transmission path of data for a second base station of second radio access technology (RAT) to a transmission path for a first base station of a first RAT, a dual connectivity (DC) being configured for the second base station with the first base station,
control the transceiver to receive, from the terminal, uplink data associated with the second base station, based on the information, and
control the transceiver to transmit, to the terminal, downlink data associated with the second base station.

14. The first base station of claim 13,
wherein the information is received by one of a packet data convergence protocol (PDCP) packet, a medium access control (MAC) control element (CE), or uplink control information (UCI), and
wherein, in case that the information is received by the PDCP packet or the MAC CE, the information includes a bit value indicating whether to activate the change of the data transmission path.

15. The first base station of claim 13, wherein the controller is configured to:
control the transceiver to transmit, to the terminal, threshold information including a first threshold value related to the second base station and a second threshold value related to the first base station;
control the transceiver to receive, from the terminal, a report including a measured value of a signal for the first base station, based on a state in which the transmission path of the data for the second base station is changed; and
control the transceiver to transmit, to the terminal, a message for configuring release of a connection to the second base station, based on the measured value being smaller than the second threshold value.
